(19) United States
(12) Patent Application Publication
(10) Pub. No.: US 2012/0229928 A1
(43) Pub. Date: Sep. 13, 2012

(54) DISK STORAGE DEVICE AND METHOD FOR MEASURING HEAD FLYING HEIGHT

(75) Inventor: Yuji Sakai, Yokohama-shi (JP)

(73) Assignee: KABUSHIKI KAISHA TOSHIBA, Tokyo (JP)

(21) Appl. No.: 13/296,114

(22) Filed: Nov. 14, 2011

(30) Foreign Application Priority Data
Mar. 11, 2011 (JP) 2011-054478

(51) Int. Cl. G11B 27/36

(52) U.S. Cl. 360/31; G9B/27.052

(57) ABSTRACT

According to one embodiment, a disk storage device comprises a controller, a recording module, a read module, and a detector. The controller is configured to control a head flying height with respect to a storage medium to a predetermined value. The recording module is configured to record a measurement signal on the storage medium when the controller controls the head flying height to the predetermined value. The read module is configured to read the measurement signal from the storage medium when the controller controls the head flying height to the predetermined value. The detector is configured to detect the head flying height based on the measurement signal read from the read module.

### CROSS-REFERENCE TO RELATED APPLICATIONS

This application is based upon and claims the benefit of priority from prior Japanese Patent Application No. 2011-054478, filed Mar. 11, 2011, the entire contents of which are incorporated herein by reference.

### FIELD

Embodiments described herein relate generally to a technique to measure the flying height of a head used in a disk storage device.

### BACKGROUND

In general, a disk storage device (hereinafter sometimes referred to a disk drive) typified by a hard disk drive performs a data read or write operation with a head flying over a disk that is a magnetic storage medium. The flying height of the head affects the characteristics of data recording and reproduction and is thus preferably set to an optimum value.

In particular, in recent years, much effort has been made to develop a technique to reduce the flying height of the head with respect to a disk. As a technique to control the flying height, a dynamic flying height (DFH) control technique has been widely put into practical use. In the DFH control technique, a heater coil is provided in a slider of the head and current is passing through the heater coil to heat and thermally expand a read/write head element. The heating control makes the flying height of the head constant.

It has been found that the flying height of the head varies depending on environmental temperature and a radial position (track position) on the disk. For example, a relatively high environmental temperature serves to reduce the flying height, whereas a relatively low environmental temperature serves to increase the flying height. In general, the increased flying height of the head increases an error rate when data is reproduced from the disk.

Thus, in recent years, techniques have been examined in which the flying height of the head is constantly accurately measured and controlled by the DFH control technique so that the measured flying height is constant and low. An effective method of accurately measuring the flying height of the head is as follows. In a manufacturing stage of a disk storage device, a flying height measurement signal formed of a single frequency is recorded on a disk. When the disk storage device is in use, the head reads the measurement signal from the disk, and the flying height is then calculated based on the ratio of the amplitude component of a fundamental wave corresponding to the read measurement signal to the amplitude component of a triple harmonic wave.

A magnetic recording scheme involves a phenomenon called a superparamagnetic effect or thermal decay. In the phenomenon, magnetization recorded on the disk weakens as time elapses, thus degrading recorded signals. Hence, the flying height measurement signal is also degraded as time elapses. Consequently, the above-described measurement method disadvantageously results in measurement errors when the flying height of the head is measured.

To deal with this problem, effort has been made to develop a technique to detect whether or not the recorded signals are degraded. In this technique, a data stream prerecorded on the disk is used to measure the flying height. Furthermore, a data stream for detection of degradation caused by the superparamagnetic effect or thermal delay is newly recorded on the disk at a location different from that where the measurement signal is recorded. Then, the flying height is measured by reproducing the two signals. If the difference between the two measured values is equal to or greater than a threshold, the technique determines that the signal has been degraded by the superparamagnetic effect or thermal delay. Then, the measured value of the flying height is corrected or the data stream for measurement of the flying height, determined to have been degraded, is recorded again on the disk (or updated).

However, in this method, if recording conditions (the air pressure, temperature, humidity, and flying height during recording) for the original data stream for measurement of the flying height are different from those for the data stream for detection of degradation, the difference in recoding conditions corresponds to the difference in measured value. This prevents the difference in measured value from being determined to be caused only by the superparamagnetic effect or thermal delay. Thus, appropriately correcting the measured value is difficult.

Therefore, disadvantageously, the conventional measurement of the head flying height cannot be freed from the impact of measurement errors resulting from the elapsed time or the recording conditions.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating the configuration of a disk drive according to an embodiment;

FIG. 2 is an exemplary flowchart illustrating a procedure for a method for measuring flying height according to the embodiment;

FIG. 3 is an exemplary diagram illustrating how to correct a flying height measured value according to the embodiment; and

FIGS. 4A and 4B are exemplary timing charts illustrating the procedure for the method for measuring the flying height according to the embodiment.

### DETAILED DESCRIPTION

Various embodiments will be described hereinafter with reference to the accompanying drawings.

In general, according to one embodiment, a disk storage device includes a controller, a recording module, a read module, and a detector. The controller is configured to control a head flying height with respect to a storage medium to a predetermined value. The recording module is configured to record a measurement signal on the storage medium when the controller controls the head flying height to the predetermined value. The read module is configured to read the measurement signal from the storage medium when the controller controls the head flying height to the predetermined value. The detector is configured to detect the head flying height based on the measurement signal read from the read module.

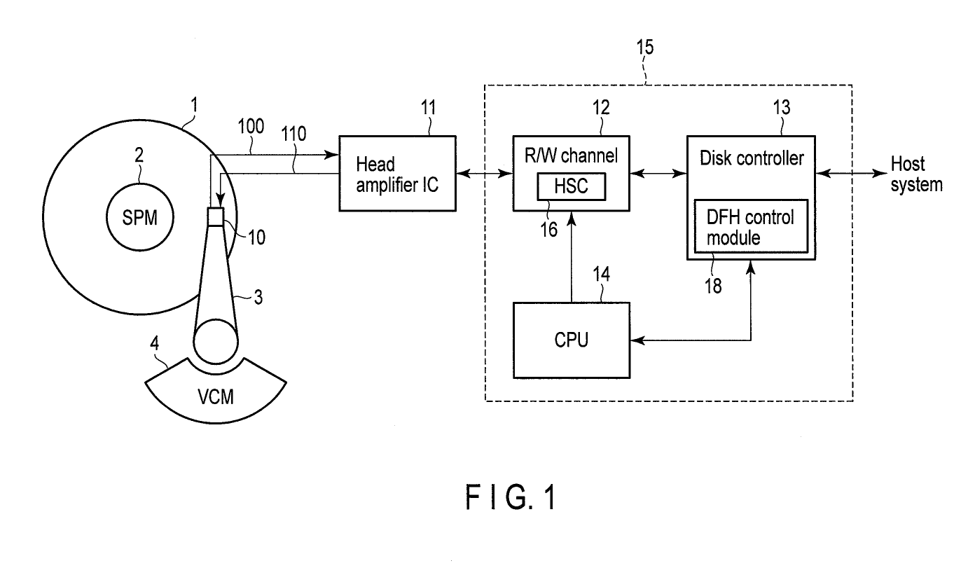

FIG. 1 is a block diagram showing an essential part of a disk drive according to the present embodiment. The disk drive is of, for example, a perpendicular magnetic recording type, and generally comprises a head disk assembly (HDA), a head amplifier integrated circuit (head amplifier IC) 11, and a hard disk controller (HDC) 15.

The HDA comprises a disk 1 that is a perpendicular magnetic storage medium, a spindle motor (SPM) 2, an arm 3 with a head 10 mounted thereon, and a voice coil motor (VCM) 4. The disk 1 is rotated by the spindle motor 2. The arm 3 and VCM 4 form an actuator. The actuator controllably moves the head 10 mounted on the arm 3 to a specified position on the disk 1 by driving the VCM 4.

The head 10 comprises a slider serving as a main body, and a read head element and a write head element mounted on the slider. The read head element reads data (including a flying height measurement signal described below) 100 recorded on the disk 1. The write head element writes data (including the flying height measurement signal described below) 110 onto the disk 1.

Though not shown, a heater coil required for DFH control is provided in the slider. The DFH control allows current to flow through the heater coil to heat and expand the read/write head element section, thus relatively reducing the flying height. In contrast, the DFH control reduces the amount of heating to contract the read/write head element section, thus relatively increasing the flying height. Furthermore, the HDA includes a temperature sensor configured to detect the ambient temperature inside the drive after the HDA is powered on.

The head amplifier IC 11 includes a read amplifier and a write driver. The read amplifier amplifies a read signal 100 read from the read head element and transmits the amplified read signal 100 to a read/write (R/W) channel 12. On the other hand, the write driver transmits a write current 110 corresponding to write data output by the R/W channel 12, to the write head element. The head amplifier IC 11 includes a heating driver configured to pass current through the heater coil under the DFH control.

The HDC 15 includes the R/W channel 12, a disk controller 13, and a microprocessor (CPU) 14. The R/W channel 12 includes a read channel configured to execute signal processing on read data and a write channel configured to carry out signal processing on write data. Moreover, the R/W channel 12 includes a harmonic sensor module (hereinafter referred to as an HSC (Harmonic sensing control) module) 16. The HSC module 16 calculates a measured value for the flying height of the head 10 and corrects the calculated value, based on the flying height measurement signal (sometimes simply referred to as the measurement signal) recorded on the disk 1, as described below. A table or a coefficient for the correction is written to a flash memory (not shown in the drawings) in the HSC module 16.

The disk controller 13 performs interface control for controlling data transfers between a host system (not shown in the drawings) and the R/W channel 12. Furthermore, the disk controller 13 includes a DFH control module 18 to perform the DFH control for controlling the current passed through the heater coil in the head 10 via the head amplifier IC 11. CPU 14 is a main controller for the drive and performs servo control for positioning the head 4 and data read/write control. Furthermore, the CPU 14 carries out a process of correcting the measured value of the flying height obtained by the HSC module 16. The CPU 14 further cooperates with the DFH control module 18 in controlling the flying height of the head 10.

First, the principle of measurement of the flying height of the head 10 will be described.

Equation (1) shown below is used to determine the relationship between a signal amplitude A obtained by using the head to reproduce a recording signal of a wavelength λ at a certain flying height d and the flying height d. Equation (1) is also called Wallace's Equation.

d=(−λ/2π)×ln A+C (1)

Here, C denotes an invariable constant that does not depend on the flying height d. Furthermore, ln means a natural logarithm.

In this case, A=C×exp(−2πd/λ) holds true.

Equation (1) includes the invariable constant C and thus fails to allow the flying height d to be obtained. Thus, an amplitude A₀ obtained with the head 10 in contact with the disk 1 is measured. The relationship between the amplitude A₀ and a corresponding relative flying height d₀ is expressed by:

d₀=(−λ/2π)×ln A₀+C (2)

Based on Equations (1) and (2), the relationship between the amplitude of the reproduced signal and the flying height is determined as follows.

(d−d₀)=(−λ/2π)×(ln A−ln A₀) (3)

In Equation (3), the invariable constant C is cancelled. Given that the relative flying height d₀=0 in Equation (3), the absolute flying height d is determined by:

d=(−λ/2π)×(ln A−ln A₀) (4)

Equation (4) indicates that the absolute flying height d is determined based on the difference in the amplitude of the reproduced signal between the two flying heights.

However, in the disk drive, the signal amplitude A varies because of a factor other than the flying height, for example, a variation in the gain of the read amplifier included in the head amplifier IC 11 which variation is caused by temperature. Thus, to cancel the factor to make the disk drive more practical, the absolute flying height d is preferably determined based on Equation (5) using the ratio of amplitude components A_{fa} and A_{fb} obtained from the same reproduction signal using two different frequencies fₐ and f_{b}.

$$d = K \times ( ln {A}_{fa} - ln {A}_{fb} ) + C \\ Here , \\ {A}_{fa} / {A}_{fb} = [ {C}_{a} \times exp ( - 2 π d / {λ}_{a} ) ] / [ {C}_{b} \times exp ( - 2 π d / {λ}_{b} ) ] . \qquad ( 5 )$$

When v denotes the peripheral speed of the disk 1,

$${λ}_{a} = v / {f}_{a} and {λ}_{b} = v / {f}_{b} . \\ K = 1 / [ 2 π ( 1 / {λ}_{b} - 1 / {λ}_{a} ) ] = v / [ 2 π ( {f}_{b} - {f}_{a} ) ] holds true .$$

Cₐ and C_{b} are invariable constants that do not depend on the flying height d.

As described above, amplitude components A_{0fa} and A_{0fb} obtained with the head 10 in contact with the disk 1 are measured. The relationship between the amplitude components A_{0f a} and A_{0fb} and the corresponding relative flying height d₀ is expressed by:

d=K×(ln A_{ofa}−ln A_{0fb})+C (6)

On the other hand, the absolute flying height d of the head 10 with respect to the disk 1 is determined from Equation (7) based on the relationship between both amplitude components A_{fa} and A_{fb} and the flying height d₀.

(d−d₀)=d=K×[ln(A_{fa}/A_{fb})−ln(A_{0fa}/A_{0fb})] (7)

Here, since the invariable constant C is cancelled, C is normally considered to be zero. In the following description, C=0. Furthermore, the amplitude measurement frequencies fₐ and f_{b} of the signal are optional, but a repetitive signal with a single frequency is normally used. Furthermore, the amplitude component A_{f1} of a fundamental wave f₁ of the repetitive signal and the amplitude component A_{f3} of a triple harmonic wave f₃ thereof are used. Additionally, to allow the amplitude components to be extracted at frequencies f₁ and f₃, the signal is subjected to discrete Fourier transformation (DFT).

The principle of measurement of the flying height has been described. However, in the disk drive, when the above measurement method is used to constantly measure the flying height, the following situation may occur.

To cancel the invariable constant C in Equation (5) to allow the absolute flying height d to be determined, it is necessary to determine not only the amplitude components A_{fa} and A_{fb} obtained at the absolute flying height d but also the amplitude components A_{0f a} and A_{0fb} obtained with the head 10 in contact with the disk 1. Here, to compensate for degradation of the recorded signal caused by the superparamagnetic effect or thermal decay, the flying height measurement signal may be recorded again or updated. When the flying height measurement signal is recorded again on the disk 1, the amplitudes of the reproduced signal change. Thus, the amplitude components A_{0fa} and A_{0fb} obtained with the head 10 in contact with the disk 1 need to be measured again.

On the other hand, the frequent contact of the head 10 with the disk 1 increases the likelihood that the head 10 or the disk 1 is worn away, resulting in performance problems. Thus, the flying height measurement signal is normally recorded only once and not recorded again. However, as described above, in the disk drive, the phenomenon called the superparamagnetic effect or thermal decay weakens the magnetization temporarily recorded on the disk 1, as time elapses. Hence, if a sufficient time passes after the flying height measurement signal is recorded, when the flying height is measured, a change in measurement signal caused by the superparamagnetic effect or thermal decay appears as an error in measurement of the flying height.

Specifically, the measured values of the amplitude components A_{0fa} and A_{0fb} obtained with the head 10 in contact with the disk 1 are increased by factors of α and β, respectively, by the superparamagnetic effect or thermal decay. Thus, the amplitude components A_{0fa} and A_{0fb} obtained change into α×A_{fa} and β×A_{fb}. The corresponding measured relative flying height dᵣ is dᵣ=K×ln [(α×A_{fa})/(β×A_{fb})]=K×ln(A_{fa}/A_{fb})+K×ln (α/β). That is, a flying height measurement error K×ln (α/β) occurs. The flying height measurement error K×ln (α/β) comprises parameters not present in the flying height to be measured, and involves a flying height measurement error that varies, even with a variation in the flying height of the head 10, depending only on the elapsed time from the end of recording.

Now, a method for measuring the flying height of the head according to the present embodiment will be described.

In the present embodiment, immediately before a flying height measurement is carried out at a certain flying height, the flying height measurement signal for the current flying height is recorded. Since the measurement signal is recorded immediately before the measurement, the measurement is not affected by the superparamagnetic effect or thermal decay. In the present embodiment, the flying height measurement signal is repeatedly recorded and reproduced (measured). If the signal is repeatedly recorded and reproduced, then even with the same flying height, a difference in any other recoding condition may lead to a measured value variation error. The difference in the recording condition other than the flying height is, for example, a non repeatable position error. During each of the repeated recording and reproduction operations, a change in recording track trajectory may result in a variation error in the measured value of the flying height even with the same flying height. The variation error during the repeated recording and reproduction (measurement) can be suppressed by obtaining a plurality of measured values and carrying out an averaging process on the measured values.

Repeated recording of the flying height measurement signal corresponds to repeated overwriting of the same signal. As described above, if a single-frequency signal is used as a measurement signal and the ratio of the component amplitude of the fundamental wave corresponding to the single-frequency signal amplitude to the component amplitude of the triple harmonic wave is used to measure the flying height, a residual component of each measurement frequency of the measurement signal affects the measured value. This may lead to a variation error in the measured value of the flying height during the repeated recording and reproduction operations. In particular, the component amplitude of the triple harmonic wave is smaller than that of the fundamental wave and is thus more significantly affected by the residual component. This adverse effect can be reduced by recording a base signal that avoids affecting the frequency component used for the measurement signal before the measurement signal is recorded. That is, a single measurement comprises recording of the base signal, recording of the measurement signal, and reproduction (measurement). For example, a 6T signal with a single frequency is used as a measurement signal, a 6T frequency component corresponding to the fundamental wave and a 2T frequency component corresponding to the triple harmonic wave are used to measure the flying height. At this time, a 1T signal not having the 6T or 2T frequency component is used as a base signal.

The base signal is not limited to a single-frequency signal but may be a random pattern signal. The random pattern signal may have a smaller variation in measured value than the single-frequency signal. The random pattern signal allows more significant suppression of a variation in measured value caused by a non-linear transition shift (NLTS) in which a magnetization transition point in the signal to be overwritten under the effect of a magnetic field in the base signal. Every time the measurement signal is repeatedly recorded, the NLTS occurs in a different condition, resulting in a variation error in the measured value. Thus, using the random pattern signal as the base signal instead of the single-frequency signal allows the occurrence condition of the NLTS to be averaged. This reduces the variation in measured value during each measurement. Additionally, the random pattern signal has the frequency component used for the measurement signal and thus involves a residual component of the measurement signal. However, the residual component of the random pattern measurement signal is negligibly smaller than that of the signal frequency signal.

The following relationships are different from each other: the relationship between DFH control amounts and flying height measured values obtained by repeated recording and reproduction of the measurement signal at a certain flying height as in the case of the embodiment, and the relationship between the DFH control amounts and flying height measured values obtained by reproducing the measurement signal recorded only once at a certain flying height. This is because in the latter relationship, the measured flying height is determined only by a change in reproduction resolution, whereas in the former relationship, the measured flying height depends not only on the change in reproduction resolution but also on a change in recording resolution. The measured flying height is often more accurate in the latter relationship. Thus, the correspondence relationship between the two relationships may be predetermined so that each of the flying height measured values obtained in the former relationship (embodiment) can be converted into (corrected to) the corresponding flying height measured value obtained in the latter relationship.

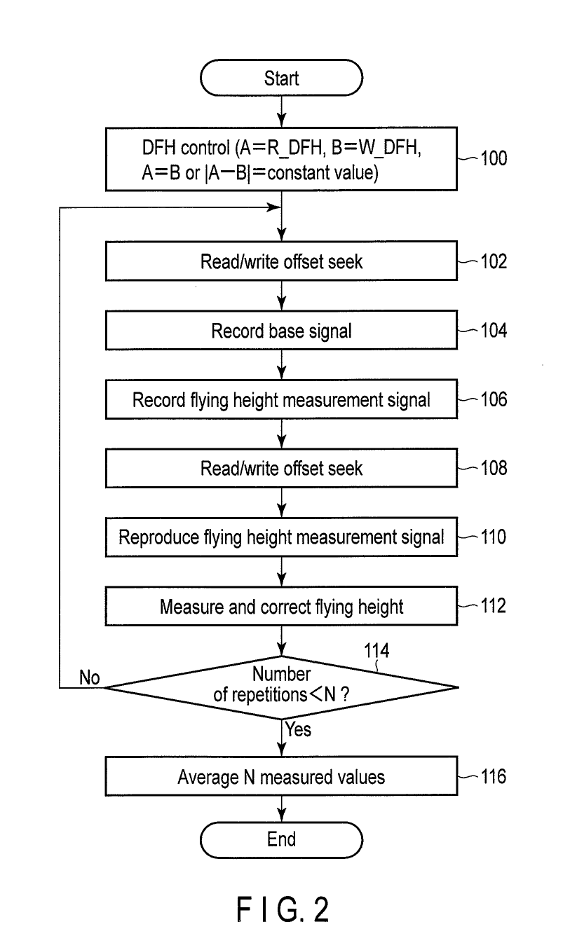

Now, the method for measuring the flying height according to the embodiment will be described with reference to FIG. 2 to FIG. 4.

In the disk drive, the CPU 14 performs an operation of measuring the flying height of the head 10 at a predetermined timing, for example, during power-on calibration at the time of power-on or while no data is being read or written.

When the flying height is measured, the DHF control is performed to set the flying height. As shown in block 100, the flying height is measured while being controlled so that the DFH control amount (R_DFH)=A of the read head element in the head 10 is equal to the DFH control amount (W_DFH)=B of the write head element in the head 10 (A=B) or so that the difference in DFH control amount |A−B| always has a constant value.

In block 102, read/write offset seeking is carried out to move the head to a target track (the track in which the flying height measurement signal is to be recorded). In block 104, for example, a base signal comprising a 1T single-frequency signal or a random pattern signal is recorded. In this case, the base signal is not necessarily recorded, and the recording of the base signal may be omitted. In block 106, the flying height measurement signal comprising, for example, a 6T single-frequency signal is recorded on the base signal. The base signal and the measurement signal are recorded in the target track in units of sectors.

In block 108, read/write offset seeking is carried out to move the head to the target track. In block 110, CPU 14 allows the head 10 to reproduce the measurement signal recorded on the disk 1. In block 112, the reproduced signal is transmitted to the R/W channel 12. Based on the read measurement signal, the HSC module 16 of the R/W channel 12 measures the flying height of the head 10 in accordance with such a measurement principle as described above (Equation (4) or Equation (7)). For example, the 6T frequency component of the fundamental wave and the 2T frequency component of the triple harmonic wave are used as the two frequency components in Equation (7).

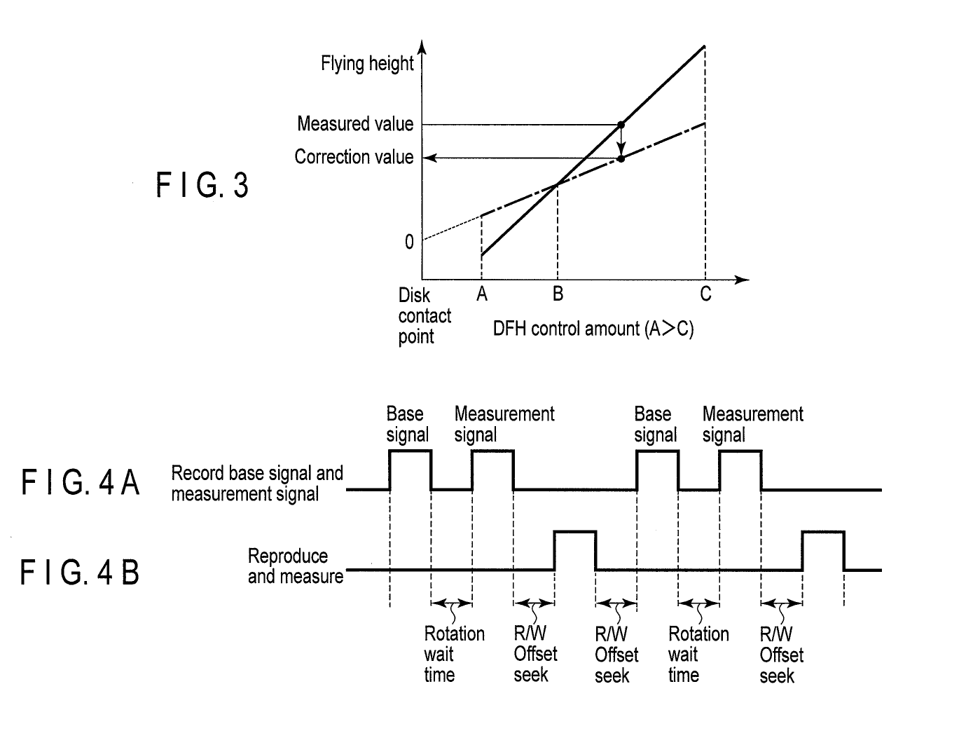

As described above, even with the same air pressure, temperature, and humidity conditions, the following relationships are different from each other as illustrated in FIG. 3: the relationship between the DFH control amounts and the flying height measured values obtained by repeated recording and reproduction of the measurement signal with the head controlled to a certain flying height under the DFH control and the relationship between the DFH control amounts and the flying height measured values obtained by reproducing the measurement signal recorded only once at a certain flying height.

FIG. 3 illustrates the two relationships. The ordinate indicates the flying height. The abscissa indicates the amount of the DFH control. A DFH control amount A for a small flying height is greater than a DFH control amount C for a large flying height. A solid line in FIG. 3 indicates the relationship between the DFH control amounts and the flying height measured values obtained by repeated recording and reproduction of the measurement signal at a certain flying height. An alternate long and short dash line in FIG. 3 indicates the relationship between the DHF control amounts and the flying height measured values obtained by reproducing the measurement signal recorded only once at a certain flying height corresponding to a predetermined DFH control amount B. The flying height measured value according to the embodiment corresponds to the relationship illustrated by the solid line. In block 112, the measured value based on this relationship is corrected (converted) to a measured value obtained from the relationship illustrated by the alternate long and short dash line. Specifically, a hard disk manufacturer writes data indicating the relationships as illustrated in FIG. 3 to the flash memory in the HSC module 16 during manufacture. A DFH control amount is determined which corresponds to a flying height measured value obtained from a signal reproduced in block 110. Then, a flying height (corrected flying height) on the characteristic illustrated by the alternate short and dash line which height corresponds to the above-described DFH control amount is determined based on data read from the flash memory in the HSC module 16. Thus, correction can be performed on the flying height depending not only on the reproduction resolution determined based on the characteristic illustrated by the solid line but also on a change in recording resolution, to obtain the flying height determined only by the change in reproduction resolution. As a result, the accuracy of the measured value can further be improved. In this case, the correction in block 112 need not necessarily be performed but may be omitted.

In block 114, CPU 14 determines whether or not the number of repetitions of the measurement has reached a predetermined value (N). If the measurement has not been repeated N times, the flow returns to block 102 and recording and reproduction of the measurement signal is repeated. If the measurement has been repeated N times, the flow advances to block 116 to carry out a process of averaging N flying height measured values. This allows a variation error in the repeated recording and reproduction (measurement) to be suppressed. The averaging in block 116 need not necessarily be carried out but may be omitted.

FIG. 4 is a diagram illustrating timings for recording of the base signal and the measurement signal, reproduction of the measurement signal, and measurement and correction of the flying height. The following periods are repeated in the following order: a read/write offset seek period, a base signal recording period, a rotation wait period, a measurement signal recording period, a read/write offset seek period, a reproduction and measurement period, a read/write offset seek period, . . . . The base signal recording period, the measurement signal recording period, and the reproduction and measurement period each correspond to at most one rotation of the disk. Alternatively, each of these periods may be shorter than one rotation of the disk, for example, may correspond to a half rotation of the disk.

As described above, the embodiment achieves one measurement of the flying height by recording and reproducing the measurement signal. The embodiment thus solves the conventional problem that the measurement signal recorded on the disk is degraded as time elapses, leading to errors in measurement of the flying height of the head. Moreover, the embodiment allows the flying height to be accurately measured without the need to newly record a data stream for detection of degradation caused by the superparamagnetic effect or thermal decay, at a location different from that where a data stream for measurement is recorded or the need to take into account the difference in recoding conditions between the measurement signal and the degradation detection signal. Thus, the flying height of the head can always be measured accurately without the need to frequently bring the head 10 into contact with the disk 1. This prevents possible performance problems resulting from abrasion of the head 10 or the disk 1.

Moreover, the accuracy of the measured value can further be improved by predetermining, under the same air pressure, temperature, and humidity conditions, the relationship between flying height measured values obtained by reproducing the measurement signal recorded only once at a certain DFH control amount and the DFH control amounts and the relationship between flying height measured values obtained by repeated recording and reproduction of the measured signal at a certain DFH control amount and the DFH control amounts, and converting and correcting each flying height measured in accordance with the latter relationship to the corresponding flying height measured in accordance with the former relationship.

Moreover, according to the embodiment, the single-frequency base signal may be recoded which avoids affecting the flying height measured value. Thus, the flying height measured value can be prevented from being affected by a residual component resulting from repeated overwriting of the measurement signal. Furthermore, a variation in flying height measured value caused by NLTS can be suppressed by recording the random pattern base signal. The use of these base signals improves the accuracy of the measured value.

Based on the flying height accurately measured as described above, the DFH control module 18 in the disk controller 13 can stably control the flying height of the head 10 to a small value.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk storage device comprising:
a controller configured to control a head flying height with respect to a storage medium to be a predetermined value;
a recording module configured to record a measurement signal on the storage medium when the controller controls the head flying height to be the predetermined value;
a read module configured to read the measurement signal from the storage medium when the controller controls the head flying height to be the predetermined value; and
a detector configured to detect the head flying height based on the measurement signal read by the read module.

2. The device of claim 1, further comprising:
a correction module configured to correct a plurality of head flying heights detected by the detector with the recording module and the read module operated a plurality of times, based on a difference between a flying height detected in accordance with a change only in reproduction resolution and a flying height detected in accordance with changes in both recording resolution and reproduction resolution.

3. The device of claim 2, wherein the correction module is configured to correct each of the plurality of head flying heights detected by the detector with the recording module and the read module operated a plurality of times, based on a relationship between an amount of control by the controller and a head flying height detected by the detector with the recording module and the read module operated a plurality of times, and a relationship between an amount of control by the controller and a head flying height detected by the detector with the recording module operated once and with the read module operated a plurality of times.

4. The device of claim 1, further comprising:
an averaging module configured to average a plurality of head flying heights detected by the detector with the recording module and the read module operated a plurality of times.

5. The device of claim 1, wherein the recording module is configured to record a base signal different from the measurement signal on the storage medium before recording the measurement signal on the storage medium.

6. The device of claim 5, wherein
the detector is configured to detect the head flying height using a frequency component corresponding to a fundamental wave of the measurement signal and a frequency component corresponding to a predetermined harmonic wave of the measurement signal, and
the recording module is configured to record a base signal with a single frequency component which signal does not comprise the frequency component corresponding to the fundamental wave of the measurement signal and the frequency component corresponding to the predetermined harmonic wave before recording the measurement signal on the storage medium.

7. The device of claim 5, wherein the recording module is configured to record a base signal with a random pattern on the storage medium before recording the measurement signal on the storage medium.

8. The device of claim 5, further comprising:
a correction module configured to correct a plurality of head flying heights detected by the detector with the recording module and the read module operated a plurality of times, based on a difference between a flying height detected in accordance with a change only in reproduction resolution and a flying height detected in accordance with changes in both recording resolution and reproduction resolution.

9. The device of claim 8, wherein the correction module is configured to correct each of the plurality of head flying heights detected by the detector with the recording module and the read module operated a plurality of times, based on a relationship between an amount of control by the controller and a head flying height detected by the detector with the recording module and the read module operated a plurality of times, and a relationship between an amount of control by the controller and a head flying height detected by the detector with the recording module operated once and with the read module operated a plurality of times.

10. The device of claim 5, further comprising:
an averaging module configured to average a plurality of head flying heights detected by the detector with the recording module and the read module operated a plurality of times.

11. A method for measuring a head flying height, the method comprising:
controlling, by a controller, a head flying height with respect to a storage medium to be a predetermined value;
recording a measurement signal on the storage medium when the controller controls the head flying height to be the predetermined value;
reading the measurement signal from the storage medium when the controller controls the head flying height to be the predetermined value; and
detecting the head flying height based on the measurement signal read by the read module.

12. The method of claim 11, further comprising:
correcting a plurality of head flying heights detected with the recording and the reading performed a plurality of times, based on a difference between a flying height detected in accordance with a change only in reproduction resolution and a flying height detected in accordance with changes in both recording resolution and reproduction resolution.

13. The method of claim 12, wherein the correcting comprises correcting each of the plurality of head flying heights detected with the recording and the reading performed a plurality of times, based on a relationship between an amount of control by the controller and a head flying height detected by the detector with the recording and the reading performed a plurality of times, and a relationship between the amount of control by the controller and a head flying height detected with the recording performed once and with the reading performed a plurality of times.

14. The method of claim 11, further comprising:
averaging a plurality of head flying heights detected with the recoding and the reading performed a plurality of times.

15. The method of claim 11, wherein a base signal different from the measurement signal is recorded on the storage medium before the measurement signal is recorded on the storage medium.

16. The method of claim 15, wherein
the head flying height is detected using a frequency component corresponding to a fundamental wave of the measurement signal and a frequency component corresponding to a predetermined harmonic wave of the measurement signal, and
the base signal comprises a single frequency component and does not contain the frequency component corresponding to the fundamental wave of the measurement signal and the frequency component corresponding to the predetermined harmonic wave before recording the measurement signal on the storage medium.

17. The method of claim 15, wherein the base signal comprises a random pattern.

18. The method of claim 15, further comprising
correcting a plurality of head flying heights detected with the recording and the reading performed a plurality of times, based on a difference between a flying height detected in accordance with a change only in reproduction resolution and a flying height detected in accordance with changes in both recording resolution and reproduction resolution.

19. The method of claim 18, wherein the correcting comprises correcting each of the plurality of head flying heights detected with the recording and the reading performed a plurality of times, based on a relationship between an amount of control by the controller and a head flying height detected by the detector with the recording and the reading performed a plurality of times, and a relationship between the amount of control by the controller and a head flying height detected with the recording performed once and with the reading performed a plurality of times.

20. The method of claim 15, further comprising
averaging a plurality of head flying heights detected with the recoding and the reading performed a plurality of times.
